(19) United States
(12) Patent Application Publication
(10) Pub. No.: US 2002/0069093 A1
(43) Pub. Date: Jun. 6, 2002

(54) Electronic reservation referral system and method

(76) Inventor: Richard C. Stanfield, Hendersonville, TN (US)

Correspondence Address: BANNER & WITCOFF, 1001 G STREET N W, SUITE 1100, WASHINGTON, DC, 20001, US

(21) Appl. No.: 09/727,708

(22) Filed: Dec. 4, 2000

(51) Int. Cl. G06F 17/60

(52) U.S. Cl. 705/5

(57) ABSTRACT

An electronic reservation referral system and method that begins with any reservation and uses interactive email sales and marketing strategies to follow up on that initial reservation or sale. It is designed to take place in the time frame between a consumer's first reservation and the actual consumption of the product(s). The method and system utilize communication systems, such as e-mail, to provide consumers access to a wide range of goods and services based upon prior purchases or reservations.

### BACKGROUND OF THE INVENTION

Despite all the e-commerce hype, on-line travel reservations made by the actual traveler remain a small percentage of travel industry bookings. Estimates show that as low as 0.43 percent of travel bookings in Western Europe and 3.5 percent in the United States were self-booked on the Internet by consumers in 1999. Furthermore, only a slight increase in market share is projected by 2002: 2.5% in Western Europe and 5% in the United States.

Expedia, an online travel service, reports that for every 100 people that go to their web site, 96 people simply browse the site, while only four trips are booked. In brief, traditional channels for travel sales (including hotel reservations, corporate reservation systems, travel agents, tour operators, etc.) remain the dominant force in the marketplace and are successfully adapting to market pressures from online competition.

Online travel services provide little in the way of real service to their travelers. They require not only that the potential traveler come to them, but also, once there, to (1) perform what amounts to self-service. Such a format inherently limits their potential for growth since (2) they can only grow as fast as the public changes their buying habits, and the willingness of travel providers to change the way they do business. The predicted change in consumer buying habits is simply not occurring fast enough as is witnessed by projections that as much as 80% of dot coms will fail by the end of 2001. Furthermore, historically, the travel industry does not change anywhere as rapidly as business in general.

### SUMMARY OF THE INVENTION

The foregoing and other deficiencies are addressed by the present invention, which is directed to an electronic reservation referral system and method that can use Internet technology, not to replace traditional travel services, but to make them dynamic. Where online travel services culminate with the booking stage, the present system begins with any travel reservation and uses interactive email sales and marketing strategies to follow up on that initial sale. It is designed to take place in the time frame between a traveler's first reservation and the actual consumption of the product(s).

The present invention relates to a method and system that utilizes communication systems, such as e-mail, to provide consumers access to a wide range of goods and services based upon prior purchases or reservations. The method and system can be used as a sales, marketing and transaction information process to combine diverse technologies. In a preferred embodiment, the method and system require only that a user or consumer have a working email account rather than complete Internet access. As a result, the system and method can be implemented as effectively on the simplest Internet appliances as on the most powerful personal computers.

### BRIEF DESCRIPTION OF THE DRAWINGS

These and other attributes of the present invention will be described with respect to the following drawings in which:

FIG. 1 is a block diagram of the electronic reservation referral-system of the present invention;

FIG. 2 is a flow chart of the operation of the method of the electronic reservation referral-system of the present invention;

FIG. 3 is a flow chart for an example of the operation of the method of the electronic reservation referral-system of the present invention with regards to a traveler to a hotel; and

FIG. 4 is a flow chart of the operation of the method of the electronic reservation referral-system of the present invention with regards to a convention.

### DETAILED DESCRIPTION OF THE PREFERED EMBODIMENTS

The system and method of the present invention can be utilized in a wide variety of industries and requires absolutely no sales and marketing efforts directly to consumers. The examples discussed below are made with regard to the travel industry, but the present invention is not meant to be limited thereto. The travel industry is a good example of the implementation of the present invention since it combines the transportation, lodging, retail, and entertainment sectors. The electronic reservation referral system of the present invention works well in the context of the travel industry because it is especially suited to a traveler because the system does not compel the traveler to initiate contact, but rather contacts the traveler after the purchase or reservation of travel related services.

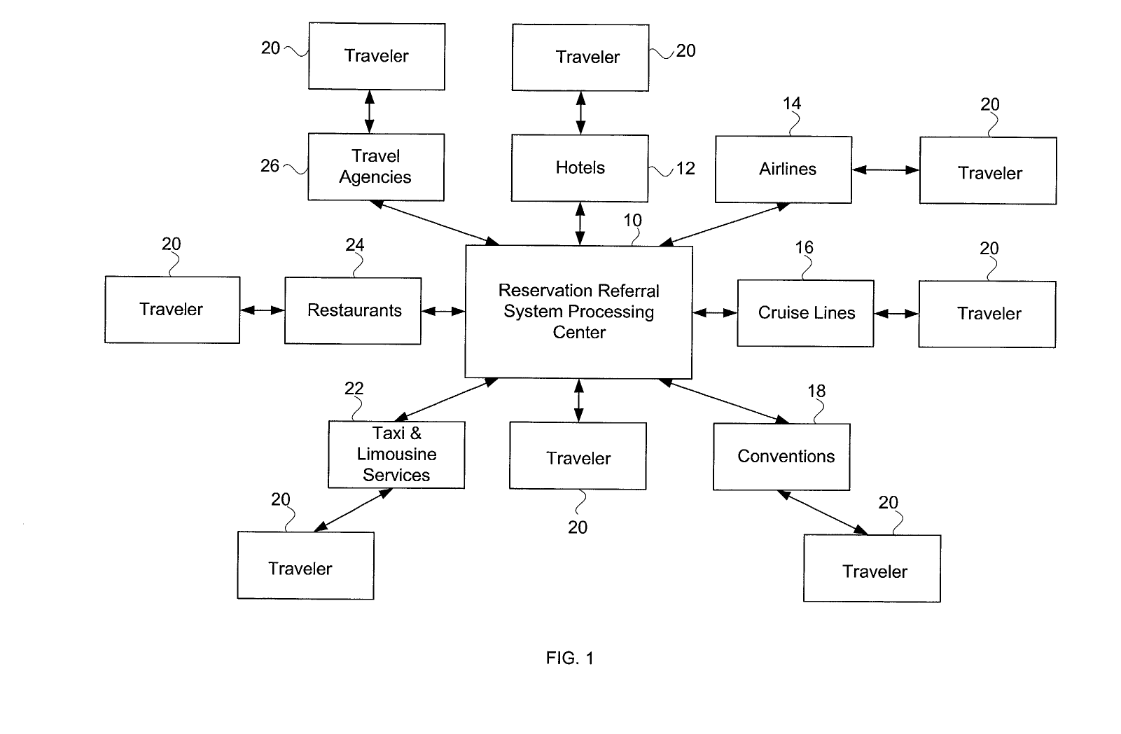

The electronic reservation referral system of the present invention can be accessed through multiple channels. A traveler 20 will reach the reservation referral-system processing center 10 indirectly after having first contacted one of the travel partners. In FIG. 1, the travel partners include hotels 12, airlines 14, cruise lines 16, conventions 18, taxi and limousine services 22, restaurants 24, and travel agents 26.

Once a traveler 20 has made a reservation with an entity that has registered to be a travel industry partner with the reservation referral-system processing center 10 of the present invention, the process searches the reservation databases of other travel industry partners for additional travel requirements for that traveler 20. The process then sends an interactive confirmation of the prior purchase with suggestions to complete the traveler's travel requirements. For example, a traveler 20 may make a hotel reservation with a hotel travel partner 12, and pertinent information regarding that traveler's travel plans is forwarded to the reservation referral-system processing center 10. The reservation referral-system processing center 10 then creates an interactive email to confirm the reservation at hotel 12 and provides flight information, for airlines 14, to and from the traveler's destination on the arrival and departure date. The traveler 20 can then complete select airline reservations with a click or two of a computer mouse or a couple of keystrokes. Unlike some forms of broadcast email or junk email, known as spam, the interactive emails sent by the system are designed to meet strict criteria.

First, each email is only generated in response to a previous transaction or reservation. The system never sends an email when the consumer has not previously initiated a transaction or reservation with a travel partner.

Second, each email only offers products and services immediately related to the previous transactions of the consumer. Email for products or services, unrelated to the previous transaction or reservation of the consumer, is not permitted lest the consumer becomes dissatisfied with the system by receiving irrelevant emails.

This process is actually stricter than existing non-spam opt in email marketing as the email from the system is directly targeted to a committed traveler with pertinent information about their upcoming trip.

Third, each email should provide brief, highly selective information not a digital catalog through which the consumer must surf.

The electronic reservation referral-system of the present invention inverts the traditional sales and marketing model, which is static and closed-ended. The traditional model considers the simple consumption of the isolated product or service as its primary goal. On the other hand, in the electronic reservation referral-system of the present invention, the initial purchase of a product or service is the first step in a domino-like sequence of potential purchases. The present system formulates an optimal sequence of purchases based upon the personal preferences of the consumer or traveler, communicated in a sequence of interactive emails generated as a result of his/her initial purchase.

The travel industry has always been plagued by the fact that travel-related businesses rarely know the arrival/departure times of the traveler (closest would be airlines) or if they are coming at all (no-shows.) These uncertainties have, and will continue to cause, dissatisfaction with the traveler, and hundreds of billions of dollars in lost revenue for the travel industry. The electronic reservation referral-system of the present invention has the potential to reduce such dissatisfaction and loss for the traveler and the travel partners, respectively. Much like the travel packages configured in advance by traditional travel agencies, the present system personalizes service according to the preferences of the consumer and allows him/her to benefit from the real-time dynamics of the marketplace. Unlike web-based travel service facilitators, which compel the consumer to sift through raw data, in effect, forcing the consumer to act as his/her own travel agent; the electronic reservation referral-system of the present invention organizes travel purchases in a compact, coherent sequence based upon a purchase or reservation already made in the travel process.

The electronic reservation referral-system of the present invention can benefit not only travelers, but also the entire global travel industry resulting in additional billions in travel industry sales and incalculable downstream revenues and taxes. The electronic reservation referral system and method unites a heretofore series of discrete, often unrelated purchases into a revenue stream that forges dynamic, interactive sales and marketing techniques while allowing for automation of additional processes and reduction of the high labor costs usually associated with the service industry.

In the hospitality industry, the lack of pertinent, practical information and pre-arrival sales techniques seriously degrade profit margins for the industry and the traveler's cherished time. The electronic reservation referral-system and method of the present invention allows travel service providers the most accurate and current information available regarding a traveler's itinerary (e.g., arrival and departure times, pre-sold products, etc.) As a result, service providers can maximize utilization and efficiency of their staff, technology and other assets through a highly accurate information/transaction management system. Similar to web-based travel service facilitators, the electronic reservation referral system and method allows travel partners to promote their latest discount rates, premium upgrades and other ancillary services; however, unlike the web-based facilitators, the electronic reservation referral-system is based upon an existing reservation or purchase, so it is far more likely that the promotion is practical, pertinent, timely and attractive to the traveler or consumer and cost effective to the travel partner or service provider.

The electronic reservation referral-system and method of the present invention is well suited for conventions, trade shows and professional meetings. The electronic reservation referral system and method can send interactive emails to potential attendees well in advance of an event, allowing them to make the appropriate reservations for the event, hotel accommodations, flights, etc. In addition to helping organizers promote their event, the electronic reservation referral system and method can help organizers forecast attendance; reserve the appropriate meeting space, market conference materials, etc. Professional organizations can use the electronic reservation referral-system of the present invention to conduct important pre-conference business, such as votes or polls, as well as to attract new members from lists of names and emails supplied by existing members. The present system will also reduce costs for event support staff and logistics.

The electronic reservation referral-system can generate significant new revenues for the travel partners through a combination of advance sales (frequently incremental), in-room sales through the hotel website and the fact that information is available on a timely basis. Consequently, the industry can provide improved services and revenues by dramatically reducing existing problems such as no-shows, providing the travel partner earlier knowledge of cancellations and group pickup, and a significant ability to drive profits through their revenue management system.

While developed from a model based on the travel industry, the electronic reservation referral-system of the present invention can be used to conduct an almost limitless number of transactions in a wide variety of industries. Thus, concert reservations processed through the electronic reservation referral system and method will be confirmed with an interactive email offering specials rates on the CDs or merchandise of the performing artist.

The system and method of the present invention can use prior information for a previous traveler, obtained from a system partner, to create destination packages whereby distressed inventory of a travel partner is checked, and interactive emails to past travelers are initiated without any human intervention.

The term travel industry as used herein includes, but is not limited to, the following: airlines, attractions, hotels, State parks, rental cars, restaurants, meeting planning companies, fuel providers, theme parks, taxi & limo services, associated retail operations, convention industry, cruise lines, convention & visitors bureaus, travel agencies, tour operators, and all travel related intermediaries.

In addition, the traveling public as used herein includes, but is not limited to, business travelers, airline travelers, leisure travelers, restaurant diners, meeting and convention attendees, attraction travelers, car rental travelers, hotel travelers, meeting planners, and taxi and limo services.

The electronic reservation referral-system of the present invention uses a series of electronic, interactive communications between travel service providers and travelers to book reservations that are based on the first sale or reservation a traveler made regarding the same trip.

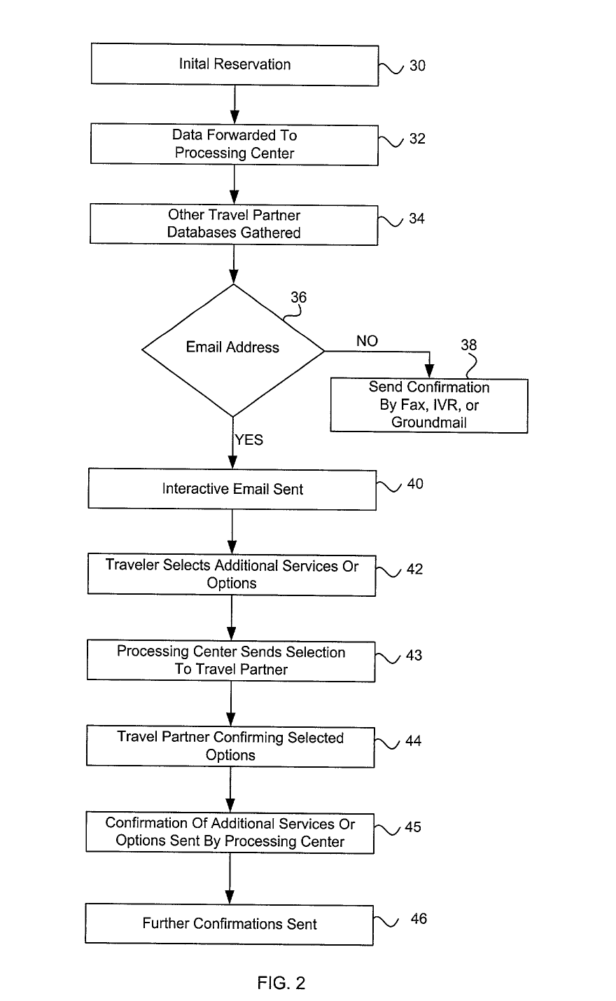

Referring to FIG. 2, a flow chart outlining the operation of the electronic reservation referral system is shown. After gathering the traveler's basic information during the initial reservation step 30, the travel provider forwards appropriate data to the reservation referral-system processing center 10 in step 32. Pertinent information from reservations systems of other partners (airline, car rental, etc.) is then gathered in step 34. The information the traveler entered is reviewed in step 36 to locate the traveler's email address. If an email address was not recorded or available at the time the reservation is made, the present system will send the information via fax, interactive voice recording (IVR) or US mail in step 38.

The reservation referral-system processing center 10 creates and sends an interactive email to the traveler confirming their first reservation and offering pertinent and practical options (with specifics such as airline departure times, etc.) so they can complete their travel requirements in step 40. In step 42, the traveler can select the other options from the interactive email, such as services from other travel partners that relate to the traveler's first reservation, or additional options from the initial travel partner. After the data processing center receives the additional selections from the traveler, the data processing center forwards the selections to the respective travel partner(s) in step 43. The travel partner confirms the selected options to the processing center in step 44. Confirmations of the selected additional options are sent to the traveler by the processing center in step 45.

Additional emails or other reminders will be sent automatically, in a domino like pattern, to offer additional practical and pertinent information or reservation options in step 46. After the traveler has completed his/her trip, one or more electronic communications can be sent to poll the traveler's satisfaction with the travel partners he/she utilized, in step 46.

The initial reservation step 30 does not have to have been initiated by the traveler. If the traveler belongs to an association that has annual or regular conventions and the association or convention organizer is a travel partner with the electronic reservation referral system of the present invention, then the association or convention organizer can initiate the reservation step 30 by contacting all the association members. Alternatively, if the traveler is a past user of the present electronic reservation referral system or a previous customer of a travel partner, a travel partner the traveler has previously used may initiate the reservation step 30. The previously used travel partner could take such a step to sell distressed inventory (for instance limited packages.)

In the instance where a traveler does not have email, the confirming reminders will be sent by fax and can include messages encouraging the traveler to obtain an email account and/or offers from Internet service providers and email/Internet appliances for email services. Such Internet Service/Product Providers may also be partners to the present system.

Unlike some forms of broadcast email or spam, the interactive emails from the present electronic reservation referral system have to meet strict criteria.

First, each email is only generated in response to a previous transaction or reservation. The system never sends an email when the consumer has not previously initiated a transaction or reservation with a travel partner.

Second, each email only offers products and services immediately related to a previous transaction of the consumer. Email for products or services, unrelated to a previous transaction or reservation of the consumer, is not permitted lest receiving irrelevant emails dissatisfies the consumer.

Third, each email should provide brief, highly selective information not a digital catalog through which the consumer must surf.

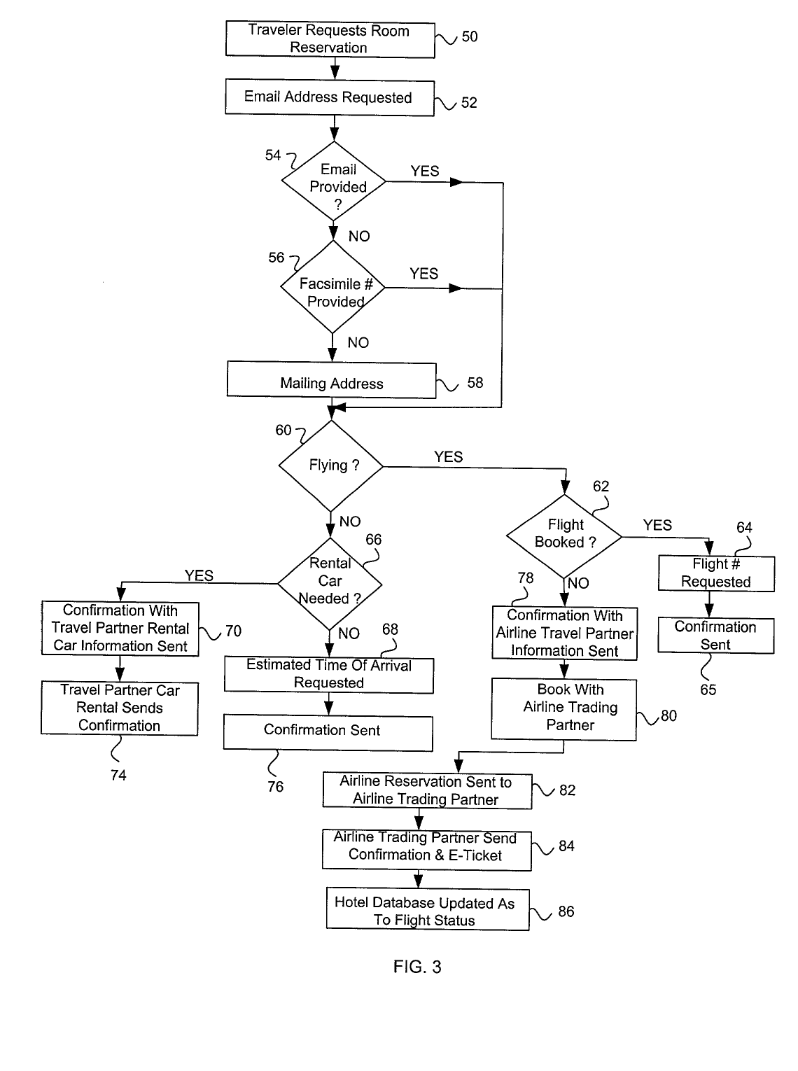

Referring to FIG. 3, in order to provide better understanding of the system and method of the present invention the following is a partial example of a series of transactions between a traveler and his/her travel providers.

The traveler in step 50 first requests a room reservation with a travel partner via one of the following: phone (hotel or travel agent), reservation card (convention or special package ad), or Internet travel booking service (Expedia). Availability and the booking itself are managed via a corporate (Hyatt) or franchise (Days Inn) central reservation system (CRS), global distribution service (GDS i.e.; Sabre, Amadeus, World Span, and Galileo) or directly by the hotel reservation department (which includes independent hotels).

Next in step 52, the booking process requests that the traveler provide an email address. If the traveler does not have an email address, or does not want to provide one in step 54, an attempt is made to obtain a facsimile number in step 56. If neither the email address or facsimile number is provided, the process will require a normal mailing address in step 58 or phone number. The traveler is then asked if he/she is flying into the city or driving in step 60. If the traveler responds that he/she is flying, an inquiry is made as to whether he/she has his/her airline booked in step 62. If the traveler has booked a flight an inquiry as to the flight number is made in step 64, after which a hotel confirmation is sent in step 65.

If the traveler indicates that he/she is flying in step 60, he/she is asked if they have reserved a rental car in step 66. If the traveler indicates that he/she has reserved a rental car in step 66, then an inquiry as to his/her estimated time of arrival at the hotel or pickup of car is made in step 68. If the traveler indicates that he/she has not reserved a rental car in step 66 he/she is sent a hotel confirmation with a list car rental travel partners in step 70. If the traveler selects a rental car from a travel partner car rental company in step 72, a confirmation is sent to the traveler in step 74, and an estimated time of arrival of the traveler is requested in step 68. After the hotel receives an estimated time of arrival in step 68, a further confirmation is sent in step 76.

Data is processed from the reservation system of the hotel to the reservation referral-system processing center 10 of the present system. The reservation referral-system processing center 10 then retrieves additional information from other travel partner's reservation databases to create and send an interactive email (or alternate) to the traveler. The email contains the following elements:

A detailed hotel reservation confirmation is then sent via email to the traveler with other travel options. This process eliminates the cost of traditional paper confirmations (including printing, postage and handling) and the confirmation process used by some hotels of providing ineffective confirmation numbers. The email confirmation is designed to reflect that it is from the hotel (or the travel provider who booked the first reservation, thereby helping to create a sense of service with the traveler well before he/she even arrives at the hotel;

Multiple marketing impressions, which are visual ads indicating sponsorship, from system's travel partners. The present system can also market this space to other companies that do not actually provide traditional travel industry products. The marketing impressions may or may not be interactive (hyperlinks.) One marketing impression space can be provided to the hotel or other travel provider to sell to its travel partners, thereby creating another profit center for a travel partner. Other than cost of sales, there is virtually no other expense to the present electronic reservation referral system or the travel provider. Therefore, profit will be high for the marketing impressions.

If the traveler indicates that they have not booked a flight, in step 62, a hotel confirmation reflecting all available flights, for the airline travel partners of the present system, to the traveler's destination city for the day of arrival and the day of departure is sent in step 78. The email could, for example, include market prices, carrier name, flight number and arrival/departure times. With a keystroke, the traveler can select, in step 80 their choice of flights and verifies the balance of information that has been pre-filled out by the present electronic reservation referral system from data collected by the hotel reservation record.

The traveler then makes any required changes and sends the email back to the reservation referral-system processing center 10, which in turn sends, in step 82, the airline reservation to the airline system of the trading partner airline. The airline system confirms the flight segments and processes an e-ticket and any other details back to the reservation referral-system processing center 10 in step 84. Another interactive email is then sent to the traveler with the updated airline information, an e-ticket and any accepted hotel record changes in step 86. Furthermore, a hotel property management system (PMS) receives the updated flight information in step 86 so that the flight status can be tracked via the net or partner's database and the traveler's arrival time at the hotel can be projected. The PMS can then automatically check in the traveler, in 30 minutes or less, prior to arrival. A greeter, or other hotel employee, can then pick up the traveler's key packet at the front door when they arrive and escort them directly to their room. By sending an email reply from their interactive email confirmation(s) the traveler's latest itinerary may be built for them and emailed on demand.

The same basic process can be performed for rental cars and other advance reservations. The present electronic reservation referral system does not require the hotel reservation be made first. Any travel reservation will be followed up with a series of practical and pertinent interactive emails.

In the following, second example a traveler reservation was made 45 days in advance of arrival and he/she booked airline tickets through the initial process. Three other interactive emails are sent at strategically dated times prior to the travel day of the traveler. Information confirmed during the confirmation for travel services remain on the itinerary with the following elements repeated or added:

All three emails have multiple marketing impressions, but from different companies.

The Traveler may be asked questions such as (all can be answered with a simple click of the mouse):

Would you prefer to have a USA Today or Wall Street Journal delivered to your door each morning of your stay?

Due to cancellations we have had a 2 1st class seats open up for your trip. We can upgrade you for only $149, a savings of 50%. If you would like to upgrade, please click below for your acceptance and you will receive a new confirmation/e-ticket. The entire $149, minus the present system transactions fees is profit and the interactive email is not sent until the revenue/yield management system has determined they will not sell above tourist class rate.

As our availability has changed, we now have a few superior (higher rated) rooms available (could also include suites) that normally have a $40 higher rate than our standard rooms. We can upgrade you for only $19 a night. If you would like to do so, please check your approval in the box below. Since the entire process will be automated there is very little, if any, real labor cost to these offers and each sale of an upgrade in a hotel is by night. Therefore in this example, the traveler is staying for 4 nights so the profit is $76. Many full service hotels would have to generate $400 or more in Food & Beverage sales to generate $76 in net profit.

If you prefer to pre-set wakeup calls for your stay, please click the time and day (or all days). The wakeup calls can be managed by a an interface to the hotels PABX and would require a small transaction fee.)

Would you like to pre-order room service for breakfast? If so please check the items you wish to order along with day and time. Most travelers are so busy by the time they get to the property that a number of possible services or product never are ordered, losing revenue opportunities. Providing travelers the opportunity to order services and product in advance will create significant additional profits for the hotels and the inherent “breakage” will drive profits up significantly.

Can we assist you with restaurant reservations at the Hotel? If the traveler says yes, a list of hotel restaurants and their latest menus are processed to the traveler via the present system. The traveler will make a reservation with day, time, and number in the party. The Traveler is offered a chance to pre-order their appetizers, a bottle of wine or perhaps their entire meal.

The hotel still has a few times available during your stay that you can take advantage of to have a massage. If you would like to schedule a massage, please approve by checking the box below and a Spa Counselor will call with-in 24 hours to establish your reservation. Thanks. The Del Coronado Hotel.

The hotel has high-speed Internet access available for your guestroom. Would you like it activated during your stay? The charge is only $9.95 a day. If the traveler responds yes, the information is interfaced with the Internet provider at the hotel to have the system activated upon check in. All charges are automatically posted to the traveler's room bill. An in-room web site portal may be available from a high speed Internet provider travel partner and would be available upon login to provide additional information for the hotel and other local attractions. After arrival, the traveler could still pre-book restaurants, tickets, etc. from their laptop or an in-room Internet appliance as the present system will continue communicating with the guest through a series of interactive emails for the traveler in the hotel such as verifying their check-out date and flight a day or so prior to anticipated departure. Checking out and emailing the traveler room checkout bill to their email address can also be provided.

A hotel that can avoid the majority of last minute early departures will be able to maximize its yield and revenue potential. Convention hotels loose millions in food & beverage when their final night banquets have drops in their counts, sometimes by the hundreds with little or no advance notice. The same problem occurs anytime the room nights and the travelers occupancy were projected and staffed for, but fail to occur due to early departure. Billions are lost by the worldwide hotel industry due to these changes and lack of timely communication.

All three emails will ask The Traveler to reconfirm their intended arrival and departure dates as well as whether they are coming at all (no-shows and cancellations.) The last interactive email may be sent only a day or so prior to arrival. Most no-shows occur because The Traveler or their representative does not cancel the reservation despite advance knowledge that they are not coming.

For the travel industry, the travel partners will benefit from increased sales and service to travelers using the present system. For airlines that are travel partners in the present electronic reservation referral system, the benefits include increased sales. Travel partner airlines can have flights listed in to and/or out of a traveler's departure city when responding to a hotel reservation made through the present system or with a travel partner hotel.

Airlines can further reduce the number of no shows who have made an airline reservation, but fail to take the reserved flight. By reconfirming travel status three or more times prior to departure via interactive email, more cancellations can be processed in time for the resell process to be successful, and for the revenue management system of the airline to fill any empty seats. By using the present system, airlines can reduce overbooking of seats directly as a result of reducing no shows.

Airlines can further reduce short notice cancellations. The multiple email reconfirming the reservation will allow a traveler to cancel earlier than if he/she canceled by traditional means or became a no-show.

Furthermore, the present electronic reservation referral system can increase sales of distressed inventory by building a database of travelers who have used a particular travel partner, the will automatically put together travel packages and send a reservation offer, including at least air and hotel reservations, to a former traveler to accept or reject at a special package rate. This process will be processing in the background based on pre-determined rates and other information while accessing actual availability of travel product with no human intervention.

Sales of first/business class seats can be increased using the present electronic reservation referral system to offer system-confirmed travelers the opportunity to upgrade their seats at a reduced premium after the determination is make that those seats will not be sold at the higher fare.

Advanced ticket sales can be increased, by offering travelers who book a reservation via a travel partner (such as a hotel), flight options well in advance of travel dates. The present system-partnered conventions can offer early signup packages that include airline seats at discounted rates allowing for a significant cash float and additional breakage.

Similar to airline travel partners, hotel travel partners will realize benefits as a result of being a travel partner in the present system. In particular, hotels can reduce no shows and late cancellations. By reconfirming travel status three days before arrival via automated interactive email, more cancellations can be processed in advance. Such checks will allow a longer lead-time to resell the rooms. Many travelers know, significantly earlier than their day of arrival, they will be no-shows or will cancel the same-day they are to check-in. The present electronic reservation referral system encourages travelers to inform the hotel travel partner of changes in their travel plans.

Decreases in no-shows and last minute cancellations will automatically reduce the requirements of hotels to overbook rooms. By being travel partners in the present system, conventions can start marketing their event and hotel rooms up to a year prior to the convention, thereby reducing the margins of overbooking even further. A traveler will have time to ensure the dates are blocked on their calendar and that they can budget expenses for travel, etc. The present electronic reservation referral system facilitates a hotel travel partner's ability to project occupancy with a higher percentage of accuracy than they can today.

Hotel travel partners can increase their occupancy rates by participating in the present system. When overbooking is lower, room pickup is earlier, thereby greatly reducing no-shows and short-term cancellations. In most instances, additional occupancy is the result. As a database is built of travelers who have used a particular hotel travel partner, the present electronic reservation referral system can automatically create packages and send a reservation, including at least air and hotel reservations, to a former traveler to accept or reject at a special package rate. The traveler can also take advantage of property-generated awards programs, such as frequent flyer miles, etc.

The earlier a hotel can make accurate projections of a sellout, the earlier the hotel management can restrict further customers to higher rated rooms. Such up-sells are 100% profit to the hotel. The more room up-sells there are, the higher the average room rate. Furthermore, higher occupancy results in additional incremental income in other departments such as restaurants, telephone, catering, and retail.

The present electronic reservation referral system allows a hotel partner to pre-sell high-speed Internet access in the traveler's room. High speed Internet access has the benefit of taking Internet traffic off the hotel's telephone switching system, thereby, removing a requirement of many hotels to upgrade their telephone switching system. If the hotel is newly constructed, the hotel will not have to buy a much larger switching system with more available trunk lines due to Internet usage and will be position for phones using the Internet in the future.

By targeting messages to incoming travelers, hotel-managed retail goods and services can be pre-sold. For example, when a traveler makes a reservation for a golf tee time through a hotel's in-house website, the traveler is presented with an opportunity to buy golf shirts or other paraphernalia bearing the hotel's logo, when their game is actually played. The hotel can market attractions, restaurants and other local venues collecting commissions on sales through the in-house website and/or through a continuation of the present systems series of emails.

Pre-marketing to incoming travelers that have the opportunity to make reservations for in-house or out-of-house commissioned restaurants, as well as pre-ordering breakfast for all days of their stay will increase food and beverage revenue and greatly improve forecasting and staffing.

The elimination of printed confirmations eliminates printing, postage and handling costs. Removing the need to process and handle confirmations reduces labor costs. Most hotels are not able to project a traveler's arrival and departure time, let alone whether they are coming or not. Often the changes to the projected occupancy at a hotel can cause drastic changes to employee schedules, with little or no notice to the employees. The foregoing is a major contributor to employee turnover and can create significant hours of employee overtime. The improvement the present electronic reservation referral system offers, to more accurately track occupancy, will reduce such employee dissatisfaction and overtime. The present electronic reservation referral system will also improve service to travelers by having the appropriate number of service employees available. All reductions in labor cost and overtime are 100% profit for the hotel travel partner's net profit.

Revenue per occupied room will be increased significantly, depending on the particular hotel and its clients, by all the items listed above.

No additional technology is required by the hotel to improve the traveler check-in process. However, by interfacing additional features between the present system and the PMS, hoteliers can do much more. The present electronic reservation referral system overcomes the last obstacles to a consistent and quick check in process. Is the traveler coming and, if so, when? By initiating the booking of the traveler's flight, coupled with re-verification of their travel intent, hotels have access to flight numbers and/or rental car/taxi arrival times. As a result, the majority of check-ins can be automatically processed prior to the traveler's arrival. Systems now exist through the airlines that keep track of where every plane is and its anticipated arrival. Interfacing that system with the present electronic reservation referral system will allow the PMS to automatically check the traveler in a set time, for example 30 minutes, prior to arrival at the hotel. Travelers can be greeted at the door, in the lobby or at the front desk. In lieu of such interfaces automated emails can alert the hotel, particularly smaller hotels creating a real point of differentiation with their competition.

There need not be any upfront capital cost for a travel partner to join the present system. The present system can be a transaction fee/commission/and/or revenue share based process. A significant impact to the travel partners is that the accumulative effects of the present electronic reservation referral system generate high profit margin processes.

The present electronic reservation referral system also provides particular benefits to the convention industry, which includes associations, trade shows and meetings. By providing secure access to the membership or attendee lists, the present system can allow organizations to vote instantaneously on important decisions and/or actions, regardless of members' locations. Presently, paid or voluntary staff or an elected Board of Directors/Executive Committee makes a large majority of decisions in membership groups. Many boards meet only once a quarter or less. The present electronic reservation referral system allows every member a vote on issues of importance to the group's leadership direction at the “grass root” level.

The present system can become a vital link in membership drives as existing members reply to an interactive email requesting email addresses of potential members or perhaps someone in the member's company.

The present electronic reservation referral system can market certification and re-certification programs, job training and other educational opportunities via interactive email to organization members-thereby increasing its number of certified or otherwise accredited members.

The present electronic reservation referral system can offer membership important updates regarding their organization or industry. The present system's brief, timely emails have the potential to create a more powerful impact rather than quarterly newsletters or organizational publications.

The present electronic reservation referral system can allow organizations to express their collective will with government, political and business organizations. For instance, a the present system interactive email might allow members to respond to an issue poll whose results will be forwarded to the offices of their respective governmental representatives.

The present electronic reservation referral system can replace many, if not all, organizational publications by automated interactive email, particularly convention registration mailers, convention confirmations, updated agendas, newsletter publications etc. By utilizing their controlled website locations entire hard-copy publications can be replaced.

With the present system handling the bulk of convention registration, organizations can decrease or redirect the use of in-house staff.

The present electronic reservation referral system can offer convention registrations and other travel arrangements much further in advance than traditional methods. The present system's early confirmation process ensures that an organization's members have plenty of time to block their personal schedules, and ensures that the members have the travel budget in place. The present system's efficiency will be extremely effective in pro-actively getting members committed to conferences before they have their schedule committed. Furthermore, members are now able to schedule other events, personal or business in the same city (increasing hotel and partner's revenues through extended stays), around the convention saving both time and money on travel.

Additional exhibitors will be inclined to participate in trade shows, if they can market to attendee lists sooner. As organizations will be emailing their members for attendance commitments much earlier, groups will be able to “sell” interactive email communications to exhibitors much sooner than they now sell mailing lists. By processing these sales through the present system, communications can be sanctioned by the group creating a much more lucrative revenue stream than they have today.

The present electronic reservation referral system can market exhibit hall registrations, or one day passes, of other, related convention or trade shows to their members when the show will be held in their member's area. With the prior permission of the present system-partner organization, the present electronic reservation referral system can offer its members a special rate to attend the other convention/trade shows with the commission revenues coming back to the present system-partner organization.

The present electronic reservation referral system can generate electronic invoices so that members can pay by credit card or print an invoice and approve for payment, thereby getting dues and other fees more quickly and easily to the organization, a major problem with most volunteer-fee based organizations. By sending an automated reminder notice, at the time of budgeting, to its members to budget dues and convention attendance, both membership dues and convention attendance will increase and revenues for the group will be realized earlier as well as having a positive cash float.

The present electronic reservation referral system can help attendees build individualized itineraries for seminar attendance by letting them select in advance those sessions of the convention or tradeshow which they wish to attend. Such a process will help the organization and the hotel to more efficiently plan the event, many times reducing expenses for both.

The interactive emails of the present electronic reservation referral system can cheaply and efficiently market an organization's products, such as books, tapes, etc.

The traveling public will also realize benefits through the present system. As stated previously, a traveler is requested to provide their email address to a partner of the present system when making a reservation. This allows the present electronic reservation referral system to work on the traveler's behalf. A traveler receives a hotel or airline email confirmation within minutes of making the reservation whether made by telephone, Internet, fax, travel agent or the present system group reservations. The traveler can then confirm that there are no mistakes in his/her reservation. Since the confirmation can be stored electronically, the traveler does not need to keep a paper copy or an easily misplaced confirmation number.

The present electronic reservation referral system also helps the traveling public make, airline bookings, automobile rentals, hotel transportation, and taxi and limousine reservations. Known flights, with times and prices to and from a destination city, are immediately emailed to a traveler, and the traveler can book or not book their choice. Similarly, choices for car rental can be presented, and the traveler can choose to book or not. Since such information comes from the travel partner, the traveler perceives a higher sense of service even before product consumption. The same holds true for taxi, limousines and hotel provided transportation.

If a hotel can reduce the amount of or frequency of overbooking, the possibility that a traveler will be turned away due to the lack of an available room, will be decreased.

Since confidential information provided by one partner to the present electronic reservation referral system is available through the present system servers, a traveler receives reservation forms already filled out, except for additional information required by that partner, or if the traveler needs to change some information.

A traveler can be provided at least partial access to a hotel's in-house website to see a presentation on the hotel's restaurant(s) and has the opportunity to book a reservation and possibly pre-order drinks, appetizers or entire meal.

Travelers will be able to pre-order room service meals for one or more days of their stay. Travelers will be able to request their choice of newspapers to be delivered each morning to their room. Travelers can preset their wakeup calls, one or more, for multiple days. Travelers can place pre-orders for items bearing a hotel partner's logo or any retail service or product available before or during the stay from the hotel's in-house website.

Availability of tickets for attractions and other events in the host city can be purchased prior to a traveler's arrival. One of the advance emails can inform travelers that high-speed Internet access is available during their stay. For hotels taking advantage of the available information from the present system, they will be able to pre-register their guests, thereby eliminating the time-consuming and expensive check-in process. Similarly, for hotels taking advantage of an in-house website, travelers can check out and save a folio to their laptop or email it to another location.

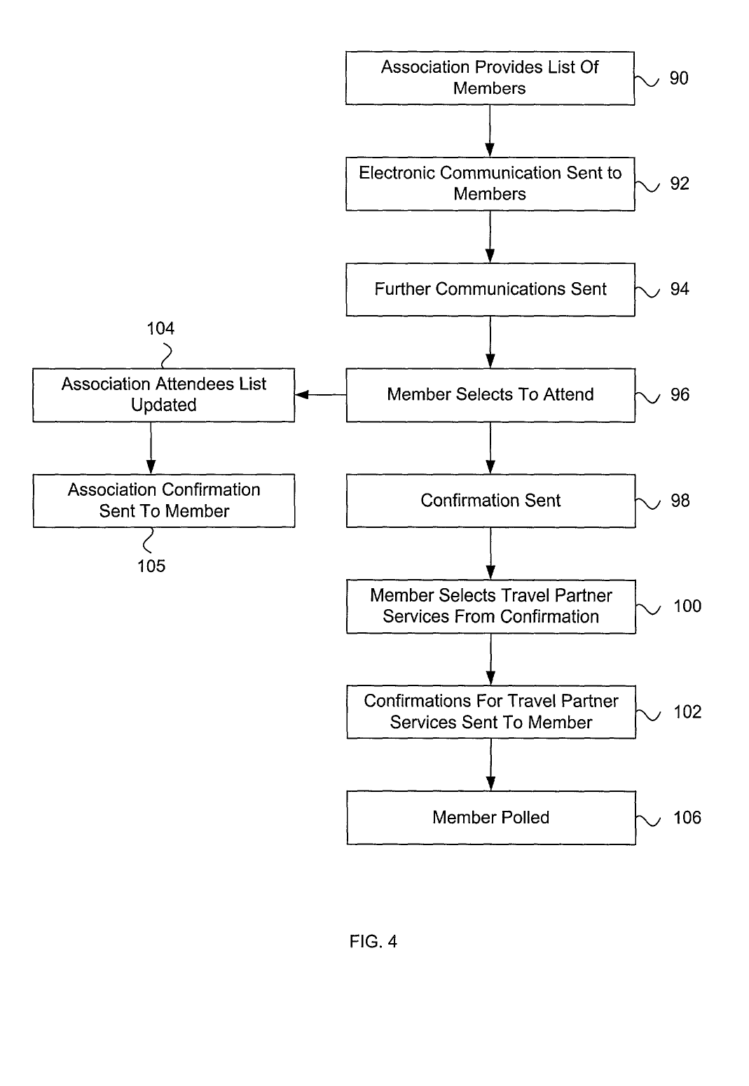

FIG. 4 is a flow chart showing the steps of the method of the present invention with regard to a convention traveler and an annual convention. In step 90 the association provides the reservation referral-system processing center 10 with a list of association members. In step 92 the reservation referral-system processing center 10 sends an electronic communication, interactive email if provided, to all the association members informing them of the annual convention. The electronic communication contains at least the name, date, city, State, hotel and an initial schedule of the convention. The member's personal information, drawn from the membership list from the association, is also provided in the electronic communication. Further electronic communications are sent at regular intervals prior to the convention in step 94. If a member responds to a reminder communication by selecting to attend the convention in step 96, a confirming communication is sent to the member in step 98. The confirming communication includes interactive travel partner information that is pertinent to the convention, i.e., airline schedules, land transportation options, hotel, etc. The member can select other travel partner products or services from the confirming communication in step 100. Secondary confirming communications are sent to the member for the other selected travel partners in step 102. After a member selects to attend the convention in step 96, the reservation referral-system processing center 10 sends an electronic communication to the association to update the attendee list in step 104. The member/attendee then receives a communication from the association confirming their attendance at the convention in step 105. After the member has gone home from the convention, one or more electronic communications can be sent in step 106, to poll the traveler's satisfaction with the travel partners or the quality of the convention he/she utilized and/or attended.

The following examples of different scenarios of operation of the present system, with regard to traveler planning, are provided to give further understanding of the present invention. As was stated previously, the present invention is not intended to be limited solely to the travel industry, and is equally applicable to other industries.

A traveler, Guest 1, calls Hotel X in Portland, Me., for a future reservation three weeks before his arrival. He requests a three-night stay and, since he is a repeat guest, is quoted a corporate room rate. Hotel X is a travel partner in the present system, and Guest 1 is asked to provide his email address. Guest 1 then proceeds to make airline and car reservations for the trip to Hotel X.

Guest 1 is currently a guest in San Antonio, Tex., and is working in his room with his laptop hooked up to the telephone data port. Thirty minutes after has made his reservation with Hotel X, a complete confirmation from Hotel X is received via email to his laptop. The confirmation confirms all the information about the booking, and includes four marketing impressions, including one from Hotel X and three others. All four marketing impressions have hyperlinks built in which can transfer Guest 1 to their homepages or a product page.

One week later, 14 days before arrival, Guest 1 receives an email through the present electronic reservation referral system from Hotel X asking if he would like to preorder any Hotel X or other local services. Items such as the Hotel X steak house, a local theme park, an historic site and other specialty restaurants that accept reservations are included. Guest 1 makes a reservation at the steak house. Furthermore, Guest 1 is asked if he would like to pre-set his wakeup calls, pre-order room service breakfast for each day of his stay, and request that the Wall Street Journal or USA Today be sent to his room daily Guest 1 pre-sets his wakeup calls, chooses room service breakfast for each day, and selects daily delivery of USA Today. Guest 1 is also requested to reconfirm his arrival and departure dates. Four marketing impressions are included once again.

One week later, seven days before Guest 1's arrival, he receives an email from Hotel X informing him that if he is bringing a laptop or PDA, high-speed Internet access is available for $9.95 per day. All Guest 1 needs to do to have it on in his room automatically upon arrival is to touch yes, and if he does not want it he chooses no. Guest 1 selects high-speed Internet access. Guest 1 is then requested to confirm his arrival and departure dates and times if they are known. Once again four marketing impressions are included.

Upon arrival at Hotel X, Guest 1 parks his car and proceeds to the front desk, provides the agent with his name, and the agent indicates that Guest 1 has been pre-registered and hands him his key packet. Guest 1 declines bell staff assistance and proceeds to his room.

After Guest 1 arrives at his room, he sets up his laptop to check his email. He connects into Hotel X's high-speed access line and retrieves his messages. The next morning, following his pre-set wakeup call and morning room service breakfast, he reads his USA Today and prepares for his day by checking his email. During the day he reminds other individuals about the dinner reservations at the Hotel X steakhouse that he had set up two weeks earlier.

Upon his return to his room, Guest 1 checks his email. One of his emails is from Hotel X asking him if he still plans on checking out two days later. Guest 1 responds that he will be checking out a day earlier and leaves for dinner. Because of his preordered wakeup call and breakfast, Guest 1 can go directly to bed after dinner.

On the second and now final day of Guest 1's stay he receives an email from Hotel X confirming his departure the next day and indicates that Hotel X has an option for checkout. In the morning he can open his email and send a response indicating that he has checked out and that Hotel X can email him a copy of his account. The email from Hotel X asks if he will need a bellman in the morning, and if so what time.

Three days after he checked out, Guest 1 receives an email from Hotel X asking if his stay was a good one and requesting that he answer some quick questions. He does so and deletes the email.

In the second example, Guest 2 is a husband and wife, and two children taking a three-day vacation at Hotel X. The person taking the reservation requests the following information:

Arrival and departure dates;

Number of required rooms;

Names of the guests;

Smoking or non-smoking rooms;

Upgrade to upscale rooms or regular rooms;

Arriving and departing by auto, flying/car rental, or flying/taxi or Hotel X limousine;

Credit card number to charge the first night deposit to; and

Email address.

The reservation is made for two connecting rooms, for a date three months later, for three nights stay at $200 per room per day. One room is smoking and one non-smoking. The upgrade is declined, and Guest 2 indicates that they will be flying in and renting a car at the airport. Guest 2 is informed that a confirmation, including a list of all available airline flights into the city on that day (as well as outbound flights on the departure date) with prices per person, as well as car rental options, will be in her email box within one hour.

Within an hour, an email arrives from Hotel X as set forth above. With a few clicks of the mouse or keystrokes Guest 2 books their airline seats and rental car. Confirmations of both reservations are received via email in less than an hour, and include electronic ticket information for their flight. Four marketing impressions, each having built-in hyperlinks, are also provided in the Hotel X confirmation.

One month later, two months before arrival, Guest 2 receives an email from Hotel X asking if they would like to preorder any of Hotel X services. Items such as massages, golf, tennis instruction, the Hotel X steak house, a local theme park, historic sites and other specialty restaurants that accept reservations are included. Guest 2 makes a reservation at the steak house. Furthermore, Guest 2 is asked if they would like to pre-set their wakeup calls, pre-order room service breakfasts for each day of their stay, and to reconfirm their arrival and departure dates. Four marketing impressions are included once again with hyperlinks.

One week before arrival, Guest 2 receives an email from Hotel X informing them that if they want to access the Internet from the computer provided in the room, high-speed Internet access is available for $19.95 per day. Guest 2 needs only to touch yes to have it on in their rooms automatically upon arrival, and if they do not want it to choose no. Guest 2 selects high-speed Internet access. Guest 2 is then requested to confirm their arrival and departure dates and times if they are known. Once again four marketing impressions are included.

Upon arrival at Hotel X, a greeter, who unloads their car and asks them if they would like to go to their room without having to go to the front desk, meets Guest 2's rental car. Guest 2 agrees and the greeter picks up their pre-registration packets and takes them to their rooms. Next, Guest 2 check their email on the in-room computer or internet/email appliance through the Hotel X's in-house website. The website has multiple marketing impressions. Guest 2 review their preordered agenda with recommendations for any open times. The daughter contacts her friends over the Internet and plays computer games with them for two hours.

Guest 2 has reservations at the Veranda for dinner that were made after their second confirmation email. With their wakeup calls already prearranged, the entire Guest 2 family goes to bed.

The following day, Guest 2 goes to the coffee shop for breakfast where a pre-ordered Wall Street Journal is brought to their table. Since tickets to the nearby theme park were in their check-in packet along with their pre-planned agenda, Guest 2 look up directions on the Hotel X in-house website. Since Guest 2 had not pre-planned dinner, they look up Hotel X's recommendations for a seafood restaurant, make their choice and make reservations. To complete their reservation, Guest 2 swipes their room card through a card reader after highlighting the desired available time.

Upon returning to their room, both parents check their email. One of their emails is from Hotel X asking them if they still plan on checking out two days later. Guest 2 responds confirming that they will check out in two days time.

On their second day Guest 2 orders two shirts with Hotel X logos from the in-house Internet site and has them delivered to their room. Upon swiping their room key through the card reader, the charges are automatically placed on their room account.

The children attend a pre-planned program for the day while the parents go antique shopping using information retrieved from the in-house Internet site. Upon returning they check their email and find one from Hotel X inviting them to a happy-hour for a two for one offer around the pool from 5:00 p.m. to 6:00 p.m. and dinner in the Polynesian restaurant, all of which they accept.

After dinner, the wife surprises her husband with a bottle of chilled champagne that she had pre-ordered two months before. They look at email from Hotel X confirming their departure the next day. The email from Hotel X asks if they will need a bellman in the morning, and if so what time.

Three days after they checked out, Guest 2 receives an email from Hotel X asking if their stay was a good one and requesting that they answer some quick questions. They do so and delete the email.

The third example relates to a husband and wife who are attending an annual convention of an association they belong to. The turnout for the convention is expected to be almost 500 people, and utilize a room block of 300 for three nights. The group has been using Company Y for several years through a benefit provided by the Convention Liaison Council. Guests 3 are familiar with the process by having used it the past two years to sign up for the previous two conventions.

Eleven months prior to the convention, Guests 3 receive an email containing at least the following components fields:

Name of the convention (already filled in);

Dates of the convention (already filled in);

City/State/Hotels (rate & room information) (already filled in;

Initial schedule for the convention (already filled in). This issue is the most significant reason that conventions cannot pre-market effectively due to the agenda not being set at that early date.

Member's name (already filled in);

Member's address (already filled in);

Telephone/facsimile numbers (already filled in);

Date of arrival (already filled in);

Date of departure (already filled in);

Preferred hotel (pre-filled in if only one hotel is being used by the convention or conference);

Number of rooms required;

Smoking or non-smoking guest room;

Requested room type;

Arrival method: fly/rental car, fly/hotel pickup. Fly/taxi or other ground transportation, and drive;

A statement from Company X is received indicating that they will receive confirmation of their group registration and hotel registration within the hour. If they are going to arrive by air and/or rental car, then they also receive information and prices on all known flights coming and going from Guests 3's home city and the convention city as well as rental car rates and information.

A request is then received asking Guests 3 for the email addresses of any other people who are not members who may want to attend the convention (others in guest 3's firm).

Since Guests 3 has not decided if they are coming to the convention, they simple delete the email. At ten months before the convention Guests 3 receive another email substantively like the previous email, but the agenda has been revised, and Guests 3 decide to go. They complete the information, and request that email be sent to an assistant, who's name and email address are provided. Minutes later a new email arrives and Guests 3 select their flights and rental car, give their credit card information, and receive electronic tickets for both within the next hour.

For the next six months Guests 3 receive an email updating them on the agenda and reconfirming that they're still coming to the convention on the dates indicated. They reply each month with a yes. Each month's confirmation has multiple marketing impressions.

One week before arrival, Guests 3 receive an email confirming the details of their trip (air, car, hotel and convention registration information). Included in this email is a statement from the hotel that due to some cancellations and room selections by guests, the hotel has upgrade rooms available that normally sell for $40 extra per night. A few are available for only $19.95 extra per night. If the guest is interested, they are directed to respond affirmatively. The email also informs them that if they want to access the Internet from the computer provided in the room, high-speed Internet access is available for $19.95 per day. Guests 3 need only to touch yes to have it on in their rooms automatically upon arrival, and if they do not want it to choose no. Guest 3 selects high-speed Internet access. Guests 3 are then requested to confirm their arrival and departure dates and times if they are known. Once again, multiple marketing impressions are included.

Upon arrival at the hotel, Guests 3 are greeted at the door and directed to the front desk. Guests 3 receive their pre-registered key packets and are escorted by the bell-staff to their rooms. Next Guests 3 check their email with their laptop computer and then go to the hotel's in-house website. The website has multiple marketing impressions.

Having described several embodiments of the electronic reservation referral system and method in accordance with the present invention, it is believed that other modifications, variations and changes will be suggested to those skilled in the art in view of the description set forth above. It is therefore to be understood that all such variations, modifications and changes are believed to fall within the scope of the invention as defined in the appended claims.

What is claimed is:

1. A system for electronic reservation referral, comprising:
a plurality of business partners;
a processing center, electronically connected to each of said plurality of business partners;
wherein a consumer can contact any of said plurality of business partners and said processing center to place a reservation for goods or services,
said processing center searches databases of said plurality of business partners for additional goods or services relating to said goods or services addressed in said reservation, and sends said consumer confirmation of said reservation, said confirmation comprising options to choose said additional goods or services.

2. A system for electronic reservation referral as recited in claim 1, wherein said confirmation is an email.

3. A system for electronic reservation referral as recited in claim 1, wherein said plurality of business partners are travel-related businesses.

4. A system for electronic reservation referral as recited in claim 1, wherein said email comprises marketing impressions for at least one of said plurality of business partners.

5. A system for electronic reservation referral as recited in claim 1, wherein said confirmation is a facsimile.

6. A system for electronic reservation referral as recited in claim 1, wherein said confirmation is a letter.

7. A method of electronic reservation referral, comprising the steps of:
receiving a reservation or purchase of goods or services from a consumer of a one of a plurality of business partners;
searching databases of remaining ones of said plurality of business partners for additional goods or services relating to said goods or services addressed in said reservation; and
sending said consumer a confirmation of said reservation with results of said searching provided in said confirmation.

8. A method of electronic reservation referral, as recited in claim 7, comprising the further step of determining if said reservation includes an email address for said consumer, and when an email address for said consumer is included, sending said confirmation as email.

9. A method of electronic reservation referral, as recited in claim 8, further comprising the step of determining if said reservation includes a facsimile number for said consumer if no email address is included, and when only a facsimile number is included for said consumer, sending said confirmation as a facsimile.

10. A method of electronic reservation referral, as recited in claim 9, wherein said step of sending said confirmation is completed by letter.

11. A method of electronic reservation referral, as recited in claim 8, wherein said results of said search included in said email confirmation are interactive hyperlinks solicit email addresses.

12. A method of electronic reservation referral, as recited in claim 7, wherein when said consumer selects one of said additional goods or services, said method further comprises the step of sending a confirmation of reservation of said additional goods and services to said consumer.

13. A method of electronic reservation referral, as recited in claim 7, further comprising the step of sending additional confirmations at intervals between a time of said reservation and delivery of said goods or use of said services.

14. A method of electronic reservation referral, as recited in claim 7, further comprising the step of including marketing impressions in said confirmation of said reservation.

15. A method of electronic reservation referral, as recited in claim 13, further comprising the step of including marketing impressions in said additional confirmations.

16. A method of electronic reservation referral, as recited in claim 7, wherein said plurality of business partners are all travel-related businesses.

17. A method of electronic reservation referral, as recited in claim 16, wherein said plurality of business partners comprise hotels, airlines, taxi services, limousine services, at tractions, State parks, rental cars, restaurants, meeting planning companies, fuel providers, theme parks, retail operations, convention industry, cruise lines, convention & visitors bureaus, travel agencies, and tour operators.

18. A method of electronic reservation referral, as recited in claim 12, wherein said plurality of business partners are all travel-related businesses.

19. A method of electronic reservation referral, as recited in claim 18, further comprising the step of, when said consumer selects one of said additional goods or services from one of said remaining ones of said plurality of business partners, said one of said plurality of business partners is informed of said selection of said additional goods or services.

20. A method of electronic reservation referral, comprising the steps of:
receiving a reservation or purchase of goods or services from a consumer of a one of a plurality of travel-related business partners;
searching databases of remaining ones of said plurality of business partners for additional goods or services relating to said goods or services addressed in said reservation;
sending said consumer a confirmation of said reservation with results of said searching provided as interactive hyperlinks in said confirmation; and
determining if said reservation includes an email address for said consumer, and when an email address for said consumer is included, sending said confirmation as email
wherein when said consumer selects one of said additional goods or services, said method further comprises the steps of:
sending a confirmation of reservation of said additional goods and services to said consumer
sending additional confirmations at intervals between a time of said reservation and delivery of said goods or use of said services, and
informing said one of said plurality of business partners of said selection of said additional goods or services from said one of said remaining ones of said plurality of travel-related business partners.

21. A method of electronic reservation referral, as recited in claim 20, further comprising the step of including marketing impressions in at least one of said confirmation of said reservation and said additional confirmations.

22. A method of electronic reservation referral, as recited in claim 20, wherein said plurality of travel-related business partners comprise hotels, airlines, taxi services, limousine services, attractions, State parks, rental cars, restaurants, meeting planning companies, fuel providers, theme parks, retail operations, convention industry, cruise lines, convention & visitors bureaus, travel agencies, and tour operators.

23. A method of electronic reservation referral, as recited in claim 20, wherein when said confirmation of said reservation fails to include an email address for said consumer, sending said confirmation of said reservation by one of facsimile, interactive voice recording and letter.
